(19) United States
(12) Patent Application Publication
(10) Pub. No.: US 2002/0133103 A1
(43) Pub. Date: Sep. 19, 2002

(54) Internet-based electrically-operated sexual aid system

(76) Inventors: Christopher Williams, Surrey (GB); Dianne Williams, Surrey (GB)

Correspondence Address: Mirick, O'Connell, DeMallie & Lougee, LLP, 100 Front Street, Worcester, MA, 01608-1477, US

(21) Appl. No.: 09/811,039

(22) Filed: Mar. 16, 2001

(51) Int. Cl. A61H 1/00

(52) U.S. Cl. 601/46

(57) ABSTRACT

An internet-based vibrator system comprising a vibrator adapted to be controlled remotely; a first computer for remotely operating the device; and a second computer for controlling the first computer remotely over a network, to allow the user of the second computer to control operation of the vibrator device through the first computer. The remote operation may be accomplished over a wire connected between the first computer and the vibrator device, or with a wireless connection between the first computer and vibrator device.

### FIELD OF THE INVENTION

This invention relates to an Internet-based electrically-operated sexual aid system.

### BACKGROUND OF THE INVENTION

For years, battery-operated vibrators have been used as sexual devices. These devices have controls such as an on/off switch that are operated while holding the device. Accordingly, the control of the device requires the physical presence of the person performing the control.

### SUMMARY OF THE INVENTION

It is therefore a primary object of this invention to provide a system that enables the control of a vibrator or other electrically-operated sexual aid device from virtually any remote location.

It is a further object of this invention to provide such a system that does not require the person controlling the sexual aid and the person using the sexual aid to be in the same location.

It is a further object of this invention to provide a system that allows a couple to more closely simulate a sexual encounter while in two separate locations.

In a preferred embodiment, the system of the invention features an internet-based electrically-operated sexual aid system comprising an electrically-operated sexual aid adapted to be controlled (for example, turned on and off, or electrically/electronically controlled in another manner) remotely; a first computer means (defined as including any electronic device capable of accomplishing the remote control, and capable of being controlled by a remote device) for remotely operating the device; a second computer means (defined as including any internet appliance or other electronic device that can send signals over a network) for controlling the first computer remotely over a network, to allow the user of the second computer means to control operation (such as on/off control, speed control, or other electronic/electrical control) of the vibrator or other sexual aid device through the first computer means. The remote operation may be accomplished over a wire connected between the first computer means and the sexual aid device, or with a wireless connection between the first computer means and sexual aid device.

### BRIEF DESCRIPTION OF THE DRAWINGS

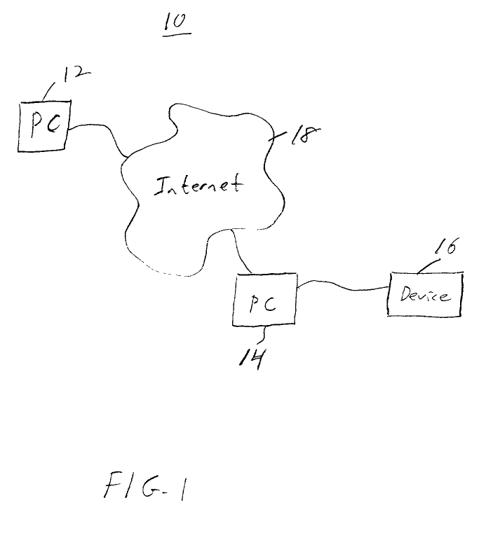

Other objects, features and advantages will occur to those skilled in the art from the following description of the preferred embodiments and the accompanying drawing, FIG. 1, which is a schematic diagram of the preferred embodiment of the system of the invention.

### DETAILED DESCRIPTION OF THE PREFERRED EMBODIMENTS

The system of this invention allows for the remote control of a sexual device, for example a vibrator. Control signals are sent by any convenient means from a computer means used by the person providing the control, to a computer means of a person using the sexual device. One network that is well suited for this is the Internet. Other networks would be equally appropriate.

The preferred embodiment of the system 10 of the invention is shown in FIG. 1. Computer means comprising controlling PC 12 is enabled to provide signals to sexual aid (vibrator) user computer means also comprising a PC 14, over Internet 18. Vibrator device 16 is connected to PC 14, either with a wire or with a wireless connection such as an infrared or rf connection, or a similar connection. Device 16 is adapted to be electrically/electronically controlled (e.g., turned on and off, speed controlled, motion controlled) by PC 14 under control of PC 12. This remote operation is accomplished in the same manner as is remote operation of any electrical device on the market today (such as by infrared or rf remote control), one example being a television with a remotely controlled on/off function.

The invention allows a couple that is not physically together to simulate a sexual experience. The user of PC 14 is also the user of device 16. The person controlling device 16 can be located anywhere in which there is Internet access, with a PC enabled to provide the appropriate commands to PC 14. Thus, the user of remote PC 12 can control the operation of device 16 in response to the appropriate interpersonal circumstances between the him or herself and the person at the location of PC 14.

Preferably, device 16 may also be operated at the device itself, so that the person using device 16 ultimately can also control its operation, for example by including the standard user-operable vibrator controls.

Other embodiments will occur to those skilled in the art and are within the following claims:

What is claimed is:

1. An internet-based electrically-operated sexual aid system comprising:
a sexual aid device adapted to be controlled remotely;
first computer means for remotely operating the device;
second computer means for controlling the first computer means remotely over a network, to allow the user of the second computer means to control operation of the sexual aid device.

2. The system of claim 1 in which the remote operation is accomplished over a wire connected between the first computer means and the sexual aid device.

3. The system of claim 1 in which the operation of the sexual aid device is accomplished with a wireless connection between the first computer means and sexual aid device.

4. The system of claim 1 in which the sexual aid device is a vibrator.
